(19) United States
(12) Patent Application Publication
(10) Pub. No.: US 2026/0275936 A1
(43) Pub. Date: Sep. 17, 2026

(54) THRUST REVERSER WITH SEALING MEMBRANE AND RETENTION SYSTEM

(71) Applicant: Safran Nacelles, GONFREVILLE L'ORCHER (FR)

(72) Inventors: Philippe WIERTEL, MOISSY CRAMAYEL (FR); Patrick BOILEAU, MOISSY CRAMAYEL (FR); Fabien JOURDAN, MOISSY CRAMAYEL (FR); Laurent Georges VALLEROY, MOISSY CRAMAYEL (FR)

(73) Assignee: Safran Nacelles, GONFREVILLE L'ORCHER (FR)

(21) Appl. No.: 19/671,834

(22) Filed: May 8, 2026

Related U.S. Application Data
(63) Continuation of application No. PCT/FR2024/051477, filed on Nov. 8, 2024.

(30) Foreign Application Priority Data
Nov. 9, 2023 (FR) 23/12215

(51) Int. Cl. F02K 1/64

(52) U.S. Cl. CPC F02K 1/64; F05D 2220/323; F05D 2260/38; F05D 2260/50

(57) ABSTRACT

A thrust reverser for an aircraft propulsion unit includes a fixed structure and a movable structure movable in translation relative to the fixed structure between a thrust position and a thrust reversal position. The thrust reverser includes at least one sealing membrane designed to divert at least part of the secondary flow outwards, and at least one retention system designed to cooperate with the fixed structure and the sealing membrane. The retention system is to subject the sealing membrane to a return force comprising a component opposite to the general direction of flow in the thrust reversal position.

### CROSS-REFERENCE TO RELATED APPLICATIONS

This application is a continuation of International Application No. PCT/FR2024/051477, filed on November 8, 2024, which claims priority to and the benefit of French Application No. FR 23/12215 filed on November 9, 2023. The disclosures of the above applications are incorporated herein by reference.

### FIELD

The present disclosure relates to a thrust reverser with a sealing membrane and a system for retaining the sealing membrane.

### BACKGROUND

The statements in this section merely provide background information related to the present disclosure and may not constitute prior art.

A thrust reverser of an aircraft propulsion unit comprises a fixed structure and a movable structure or an assembly of at least one cowl intended, in a thrust reversal position, to move longitudinally to form a radial opening in the nacelle.

A set of actuators of the thrust reverser, similar to that described in document FR 3 010 455, allows the transition from a thrust position, or operating position of the propulsion unit in flight, to the thrust reversal position, or position for redirecting part of the gases moving in the propulsion unit in the opposite direction through the radial opening.

The radial opening allows gases flowing in a secondary flow path of the propulsion unit to escape outwards. The thrust reverser further comprises a deflector extending transversely in the secondary flow path to guide the gases outwards in the thrust reversal position.

The deflector can be a flap, connected to the fixed structure by a connecting rod and to the movable structure by a rotary connection, deploying as the movable structure transitions from a thrust position to the thrust reversal position.

However, this technical solution imposes the use of different parts representing a certain mass, and the functional clearances between these parts are likely to disrupt the aerodynamics of the gas flow in the propulsion unit.

An alternative is to use as a deflector a membrane which deploys like a sail during the transition to the thrust reversal position. This sealing membrane is flexible and deploys by fastening on the fixed structure on the one hand and on the movable structure on the other hand, as described in document FR 3 131 757.

Document FR 3 131 758 A1 also describes a thrust reverser comprising a sealing membrane for diverting part of the secondary flow through a radial opening.

The sealing membrane is in contact with some parts of the movable structure and exerts axial forces in the general direction of flow on the movable structure. The use of the sealing membrane therefore imposes oversizing of the set of actuators to allow the movable structure to move from the thrust reversal position to the thrust position when comparing the membrane system to a flap system.

### SUMMARY

This section provides a general summary of the disclosure and is not a comprehensive disclosure of its full scope or all of its features.

To this end, the present disclosure relates to a thrust reverser for an aircraft propulsion unit, the thrust reverser comprising: a fixed structure provided with a front frame and an internal delimiting wall for a secondary flow path of the propulsion unit, the secondary flow path being intended to be traversed by a secondary flow in a general direction of flow, a movable structure provided with at least one cowl, the movable structure being movable in translation relative to the fixed structure along a longitudinal central axis of the thrust reverser between a thrust position and a thrust reversal position, at least one sealing membrane designed to divert at least part of the secondary flow outwards through a radial opening formed between the front frame and the movable structure in the thrust reversal position, the at least one sealing membrane extending into the secondary flow path in the thrust reversal position, at least one retention system designed to cooperate with the fixed structure and the sealing membrane, said retention system being configured to subject the corresponding sealing membrane to a return force comprising a component opposite to the general direction of flow in the thrust reversal position. The retention system applies to the sealing membrane a force comprising a component opposite to a general direction of flow of an aircraft propulsion unit.

During the transition from the thrust position to the thrust reversal position, the radial opening appears until it reaches its maximum size in the thrust reversal position.

At the same time, the sealing membrane deploys and is subjected to the secondary flow which imposes a force on it comprising a component in the general direction of flow.

The sealing membrane, as it deploys in the secondary flow path, is pressurized by the gas flow. The orientation of the resultant force evolves throughout the travel, becoming predominantly axial, that is, in the general direction of flow, in the thrust reversal position. The flow path is axially obstructed by the sealing membrane, with a flow being diverted predominantly radially just upstream of the sealing membrane in the thrust reversal position.

The sealing membrane can then abut against the movable structure and may in turn impose a force on the movable structure in the general direction of flow.

The retention system(s) make it possible to limit the movement of the corresponding sealing membrane in the general direction of flow and thus to avoid or limit the stress of the sealing membrane on the movable structure.

A sealing membrane may have one or several retention systems depending on the configurations.

In this text the terms upstream, downstream, front, rear are defined in relation to the general direction of flow.

According to one aspect of the present disclosure, said retention system is also configured to subject the corresponding sealing membrane to the return force between an intermediate return-initiating position and the thrust reversal position.

Thus, the retention system is not active (no return force with a component opposite to the general direction of flow) in the thrust position. The retention system is only activated from the intermediate return-initiating position.

In one form, the intermediate return-initiating position corresponds to 50% or more, and in one form 70% or more, of a stroke between the thrust position and the thrust reversal position.

According to the present disclosure, the fixed structure comprises a rear frame, the at least one sealing membrane having a first end fastened on or cooperating with the rear frame.

Each cowl comprises an external delimiting wall configured to delimit the secondary flow path with the internal delimiting wall in the thrust position and an external panel having an outer aerodynamic surface of the thrust reverser.

Each cowl has a cavity open towards the front frame in the thrust position and formed between the external delimiting wall and the external panel, the rear frame being located in the cavity in the thrust position so that the at least one sealing membrane is at least partially within the cavity in the thrust position.

It appears that during the deployment and retraction of the sealing membrane between the thrust position and the thrust reversal position, the sealing membrane exits the cavity and then re-enters it.

This arrangement promotes gas flow in the secondary flow path in the thrust position.

According to one aspect of the present disclosure, the at least one sealing membrane is configured to cooperate by contact with an upstream end of the external delimiting wall at least over part of a stroke of the thrust reverser between the thrust position and the thrust reversal position.

Due to the flow of gas in the general direction of flow, the sealing membrane is constrained towards the rear frame and comes into contact with the external delimiting wall, particularly in an initial part of the stroke between the thrust position and the thrust reversal position.

During this contact, the sealing membrane imposes a stress on the movable structure, with a component in the general direction of flow. The stress corresponds to the cooperation between the sealing membrane and the upstream end of the external delimiting wall. The upstream end pushes the sealing membrane in the direction opposite to the general direction of flow. The sealing membrane is thus tensioned and rubs against the upstream end like a belt or cable on a pulley, which pushes the movable structure downstream.

This stress is reduced or eliminated by the retention system. Over at least part of the stroke of the thrust reverser, the sealing membrane is in contact with the external delimiting wall, but the applied force is less.

Depending on the design, the retention system can also cause a detachment during part of the stroke between the thrust position and the thrust reversal position. During this detachment, no stress is imposed on the movable structure by the sealing membrane.

The sealing membrane can be made of a material known to those skilled in the art for this type of application. For example, it could be an unimpregnated fabric, for example aramid fibers. The sealing membrane can also be made from a composite material with a particularly flexible matrix, for example aliphatic polyurethane or silicone. In this case, the matrix provides low flexural recovery capability, and the behavior of the obtained structure is indeed that of a membrane.

According to one aspect of the present disclosure, the sealing membrane is configured to fold in a perfectly reversible manner. In one form, this folding can correspond to an elastic extension or to slippage of fibers of the sealing membrane.

In particular, the folding of the sealing membrane has a very small radius of curvature relative to the surface of the sealing membrane.

According to one aspect of the present disclosure, the sealing membrane has a very small thickness relative the surface of the sealing membrane. For example, the thickness is in the range of 0.1 to 3mm. For information purposes, it is observed that the sealing membrane behaves like a boat sail when pressurized.

The external delimiting wall is an acoustic panel or sliding panel of the transcowl.

According to the present disclosure, each retention system comprises a connecting element configured to cooperate with a corresponding fastening point of the fixed structure on one end of the connecting element and configured to cooperate with the corresponding sealing membrane at an attachment point on another end of the connecting element, the attachment point being in the cavity in the thrust position.

In one form, the fastening point is located on the front frame.

This arrangement allows the sealing membrane to be subjected to a return force in the direction opposite to the general direction of flow by a simple mechanism for fastening the sealing membrane to the front frame via a connecting element.

According to one aspect of the present disclosure, the connecting element is configured to be contained within a space delimited by the cavity and the front frame in the thrust position so as to be outside the secondary flow path.

This configuration of the connecting element in the thrust position avoids any disruption of the secondary flow and thus any imbalance of the engine assembly.

According to one aspect of the present disclosure, in the thrust position, the first end is located in the cavity so that the sealing membrane is at least partially in contact with the external delimiting wall inside the cavity, the attachment point being located at a determined distance from the first end, the determined distance defining an intermediate position of total detachment of the sealing membrane from the external delimiting wall which is located between the thrust position and the thrust reversal position, the sealing membrane no longer being in contact with the external delimiting wall from the intermediate detachment position.

In other words, between the intermediate detachment position and the thrust reversal position, the sealing membrane is no longer in contact with the movable structure thanks to the action of the connecting element.

At the end of opening of the movable structure, the sealing membrane does not disrupt the movement of the movable structure, which results in less effort to move the movable structure at the end of opening and at the beginning of closing.

When closing towards the thrust position, the sealing membrane comes into contact with the external delimiting wall in the intermediate detachment position. It should be noted that the forces exerted by the sealing membrane on the external delimiting wall are, however, limited by the action of the connecting element that holds the sealing membrane upstream.

This arrangement thus facilitates the movement of the movable structure which is little disrupted by the presence of the sealing membrane.

The determined distance defines the stage of opening of the movable structure from which the connecting element is tensioned and applies a return force on the sealing membrane.

The greater the determined distance, the earlier the return force on the sealing membrane appears. One possibility is to define a force corresponding to an opening of approximately 80%. A more premature tensioning of the connecting element is in the range of 70% of the opening.

The tensioning by the connecting element does not necessarily coincide with the moment when the sealing membrane ceases to be in contact with the movable structure. The sealing membrane may be tensioned while still in contact with the movable structure, and then detach completely from the movable structure as the opening progresses.

According to one aspect of the present disclosure, the connecting element is sized to extend in a straight line between the attachment point and the fastening point in the thrust position.

This sizing of the connecting element allows it to be held inside the cavity in the thrust position.

According to one variant, the connecting element may have a length greater than a straight-line distance between the attachment point and the fastening point in the thrust position. The connecting element is then slack in the thrust position and at the beginning of travel towards the thrust reversal position.

The length of the connecting element also influences the stage of opening of the movable structure from which the connecting element is tensioned.

According to one aspect of the present disclosure, the retention system further comprises an elastic retention device configured to apply a return force to the connecting element towards the fastening point.

This arrangement makes it possible to reduce the force applied by the sealing membrane on the movable structure by retaining the connecting element more upstream.

According to one possibility, the elastic retention device is an elastic part connecting the front frame to the connecting element. The elastic part may be a cord made of an extensible material fastened on the fixed part, in particular the front frame, and on the connecting element.

The elastic part is configured to extend as the movable structure opens. This gradually and then completely detaches the sealing membrane from the movable structure.

According to another possibility, the elastic retention device is a winder mounted on or formed into the front frame. The winder comprises a return spring sized to allow the sealing membrane to gradually detach from the movable structure during opening. As an alternative to the spring, a motor, for example an electric one, can be used as the return force.

According to one aspect of the present disclosure, the connecting element is a cable or strap of fixed length. Alternatively, other devices could be used as long as they fulfill the function of connecting the front frame and the sealing membrane.

According to one aspect of the present disclosure, the retention system also comprises a reinforcement element configured to link the connecting element to the sealing membrane at a reinforcement location separate from the attachment point.

This arrangement makes it possible to provide that the connecting element is correctly fastened to the sealing membrane. Moreover, the reinforcement location, separate from the attachment point, makes it possible to define the shape assumed by the sealing membrane in the thrust reversal position more precisely than with the attachment point alone.

According to one aspect of the present disclosure, the reinforcement element is a cable or strap made of the same material as the connecting element and connected to the latter.

According to one aspect of the present disclosure, each sealing membrane comprises a second end opposite to the first end and connected to the internal delimiting wall by a corresponding connecting rod or other mechanical system, the connecting rod or other mechanical system being configured to move the second end between a lower position near or in contact with the internal delimiting wall in the thrust reversal position and an upper position near or in contact with the external delimiting wall in the thrust position.

In the lower position, the sealing membrane extends into the secondary flow path at least partially transversely to the general direction of flow over almost all or all of the flow section, while in the upper position the sealing membrane is almost or totally no longer present in the secondary flow path and has entered the cavity.

According to one aspect of the present disclosure, the other mechanical system may comprise an arrangement of cables and corresponding guides connecting the second end to the fixed structure, said arrangement being configured to be set in motion by the movement of the movable structure between the thrust position and the thrust reversal position.

According to one aspect of the present disclosure, each connecting rod has a lower end configured to be mounted on the internal delimiting wall, in one form via a pivot or ball joint.

Each connecting rod is designed to move from the upper position in which said connecting rod projects radially into the secondary flow path to the lower position in which said connecting rod is folded downstream.

In the upper position, each connecting rod can adopt a radial or substantially radial orientation relative to the longitudinal central axis of the thrust reverser, while in the lower position, each connecting rod can adopt an axial or substantially axial orientation.

Each connecting rod includes a return equipment configured to apply a force tending to tilt said connecting rod towards the lower position. This provides proper positioning of the sealing membrane during the transition to the thrust reversal position.

The connecting rods are spaced circumferentially from each other within the secondary flow path, and their number can vary, for example, from two to ten, depending on the angular extent of the sealing membrane.

According to one aspect of the present disclosure, the movable structure is configured to slide relative to the fixed structure via a rail-and-slide system of the thrust reverser, the rail-and-slide system being configured to guide the movable structure from front to back during the opening phase of the thrust reverser up to the thrust reversal position, and from back to front during the closing phase of the thrust reverser up to the thrust position, the thrust reverser comprising a set of actuators formed in the fixed structure to move the movable structure relative to the fixed structure.

According to one aspect of the present disclosure, the set of actuators is configured to be set in motion by at least one cylinder of the thrust reverser associated with a flexible shaft of the thrust reverser. A dedicated control assembly of the thrust reverser controls the at least one cylinder and the set of actuators.

The use of the retention system makes it possible to avoid oversizing the at least one cylinder. Indeed, without a retention system, the sealing membrane is in contact with the external delimiting wall, which creates resistance to the movement of the movable structure, particularly at the end of opening and during the closing of the movable structure.

According to one aspect of the present disclosure, the thrust reverser comprises at least one set of cascade vanes or an equivalent deflector device such as a set of deflector vanes having an angular amplitude identical or similar to that of the corresponding cowl. The set of cascades is fastened and extends between the front frame and the rear frame.

According to one aspect of the present disclosure, the movable structure comprises two cowls. In one form, each cowl forms a complementary hemispherical half-shell so as to define a portion of the nacelle.

According to one possibility, a single sealing membrane is associated with each cowl of the thrust reverser.

According to another possibility, several circumferentially adjacent sealing membranes are associated with each of the two cowls.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic longitudinal sectional view of a thrust reverser with a sealing membrane.

FIG. 2 is a schematic longitudinal sectional view of the thrust reverser in the thrust position with a system for retaining the sealing membrane.

FIG. 3 is a schematic longitudinal sectional view of the thrust reverser between the thrust position and a thrust reversal position.

FIG. 4 is a schematic longitudinal sectional view of the thrust reverser in the thrust reversal position.

FIG. 5 is a schematic longitudinal sectional view of the thrust reverser with an elastic retention device.

FIG. 6 is a schematic longitudinal sectional view of the thrust reverser with a winder as an elastic retention device.

FIG. 7 is a schematic longitudinal sectional view of the thrust reverser with the retention system including a reinforcement element.

FIG. 8 is a perspective view of a front frame of the thrust reverser, a sealing membrane and retention systems in the thrust reversal position.

FIG. 9 is a perspective view of a cylinder and a set of actuators of the thrust reverser.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description of the figures defined above, the same elements or elements fulfilling identical functions may retain the same references in order to simplify the understanding of the present disclosure.

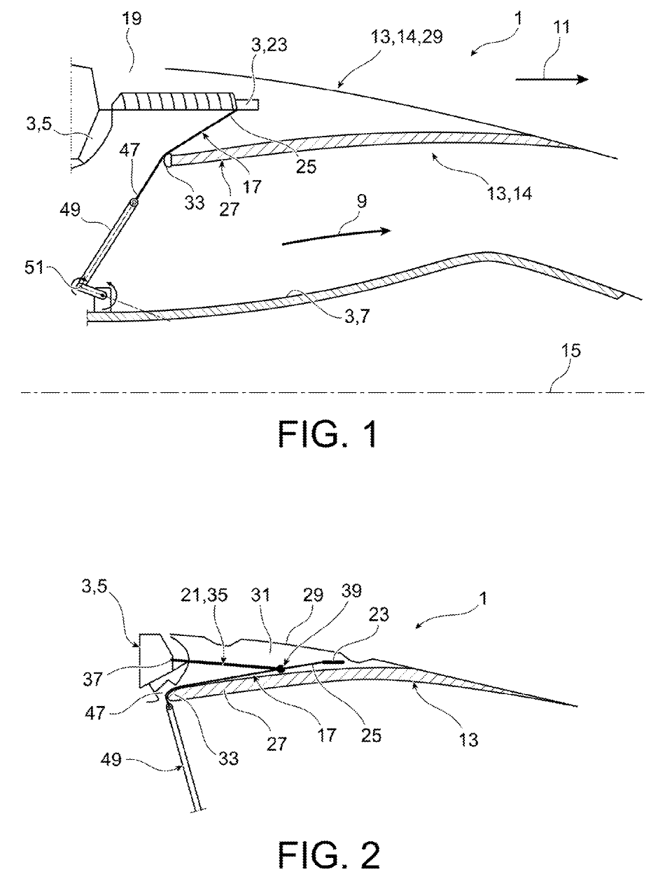

As illustrated in FIG. 1, a thrust reverser 1 for an aircraft propulsion unit comprises a fixed structure 3 provided with a front frame 5 and an internal delimiting wall 7 for a secondary flow path 9 of the propulsion unit, the secondary flow path 9 being intended to be traversed by a secondary flow in a general direction of flow 11.

The thrust reverser 1 comprises a movable structure 13 provided with at least one cowl 14, the movable structure 13 being movable in translation relative to the fixed structure 3 along a longitudinal central axis 15 of the thrust reverser 1 between a thrust position illustrated in FIGS. 2, 5 and 6 and a thrust reversal position illustrated in FIGS. 4, 7 and 8.

In one form, the movable structure comprises two cowls 14, each cowl 14 forms a complementary hemispherical half-shell so as to define a portion of the nacelle.

According to one possibility, a single sealing membrane 17 is associated with each cowl 14 of the thrust reverser 1.

According to another possibility, several circumferentially adjacent sealing membranes 17 are associated with each of the two cowls 14.

Moreover, the thrust reverser 1 comprises at least one sealing membrane 17 designed to divert at least part of the secondary flow outwards through a radial opening 19 formed between the front frame 5 and the movable structure 13 in the thrust reversal position, the at least one sealing membrane 17 extending into the secondary flow path 9 in the thrust reversal position.

As illustrated in FIGS. 2 to 9, the thrust reverser 1 further comprises at least one retention system 21 designed to cooperate with the fixed structure 3 and the corresponding sealing membrane 17.

The retention system 21 is configured to subject the corresponding sealing membrane 17 to a return force comprising a component opposite to the general direction of flow 11 in the thrust reversal position and between the thrust reversal position and the thrust position.

During the transition from the thrust position to the thrust reversal position, the radial opening 19 appears until it reaches its maximum size in the thrust reversal position.

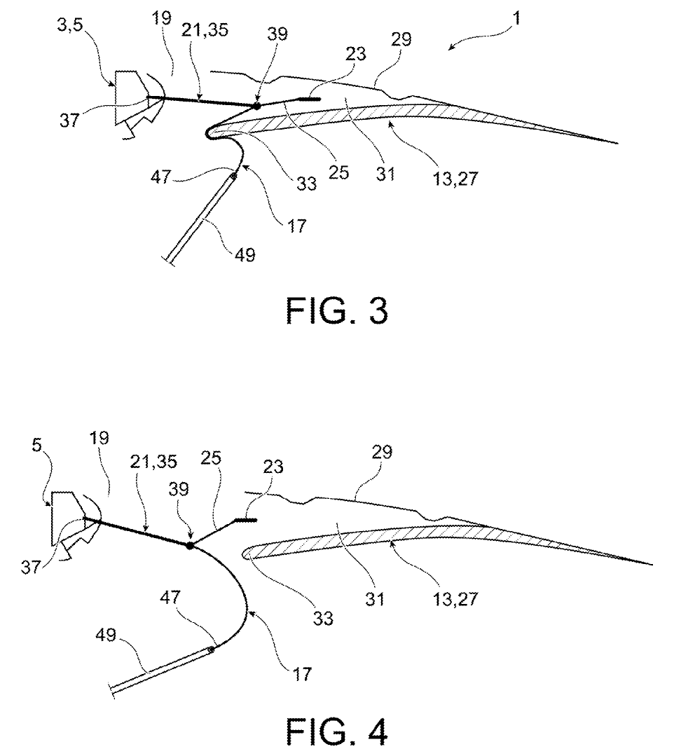

At the same time, the sealing membrane 17 deploys and is subjected to the secondary flow which imposes a force on it in the general direction of flow 11. The sealing membrane 17 can then abut against the movable structure 13 as illustrated in FIGS. 1 and 3.

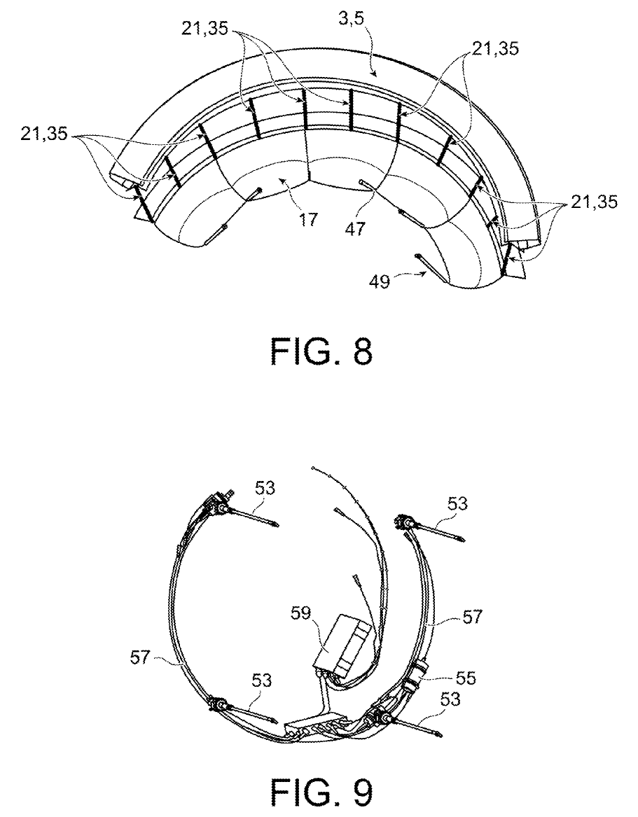

A sealing membrane 17 can have several retention systems 21 depending on the configurations as illustrated in FIG. 8.

In this text the terms upstream, downstream, front, rear are defined in relation to the general direction of flow 11.

The retention system 21 is also configured to subject the corresponding sealing membrane 17 to the return force between an intermediate return-initiating position and the thrust reversal position.

Thus, the retention system 21 is not active in the thrust position, that is to say there is no return force with a component opposite to the general direction of flow 11.

The retention system 21 is activated only from the intermediate return-initiating position. In one form, the intermediate return-initiating position corresponds to 50% or more, and in one form 70% or more, of a stroke between the thrust position and the thrust reversal position.

The fixed structure 3 comprises a rear frame 23, the at least one sealing membrane 17 having a first end 25 fastened on or cooperating with the rear frame 23.

Each cowl 14 comprises an external delimiting wall 27 configured to delimit the secondary flow path 9 with the internal delimiting wall 7 in the thrust position and an external panel 29 having an outer aerodynamic surface of the thrust reverser 1.

Each cowl 14 has a cavity 31 open towards the front frame 5 in the thrust position and formed between the external delimiting wall 27 and the external panel 29, the rear frame 23 being located in the cavity 31 in the thrust position so that the at least one sealing membrane 17 is at least partially in the cavity 31 in the thrust position and cooperates by contact with an upstream end 33 of the external delimiting wall 27 at least over part of a stroke of the thrust reverser 1 between the thrust position and the thrust reversal position.

It appears that during the deployment and retraction of the sealing membrane 17 between the thrust position and the thrust reversal position, the sealing membrane 17 exits the cavity 31 and then re-renters it.

Due to the flow of gas in the general direction of flow 11, the sealing membrane 17 is constrained towards the rear frame 23 and comes into contact with the external delimiting wall 27, particularly in an initial part of the stroke between the thrust position and the thrust reversal position.

During this contact, the sealing membrane 17 imposes a stress on the movable structure 13, with a component in the general direction of flow 11. The stress corresponds to the cooperation between the sealing membrane 17 and the upstream end 33 of the external delimiting wall 27. The upstream end 33 pushes the sealing membrane 17 in the direction opposite to the general direction of flow 11. The sealing membrane 17 is thus tensioned and rubs against the upstream end 33 in the manner of a belt or cable on a pulley, which pushes the movable structure 13 downstream.

This stress is reduced or eliminated by the retention system 21. On at least part of the stroke of the thrust reverser, the sealing membrane 17 is in contact with the external delimiting wall 27 but the applied force is less.

Depending on the design, the retention system 21 can also cause a detachment over part of the stroke between the thrust position and the thrust reversal position. During this detachment, no stress is imposed by the sealing membrane 17 on the movable structure 13.

The sealing membrane 17 can be made of a material known to those skilled in the art for this type of application. For example, it could be an unimpregnated fabric, for example aramid fibers. The sealing membrane can also be made from a composite material with a particularly flexible matrix, for example aliphatic polyurethane or silicone. In this case, the matrix provides low flexural recovery capability, and the behavior of the obtained structure is indeed that of a membrane.

The sealing membrane 17 is configured to fold in a perfectly reversible manner. In one form, this folding can correspond to an elastic extension or to slippage of fibers of the sealing membrane 17.

In particular, the folding of the sealing membrane 17 has a very small radius of curvature relative to the surface of the sealing membrane 17.

The sealing membrane 17 has a very small thickness relative to the surface of the sealing membrane 17. For example, the thickness is in the range of 0.1 to 3mm. For information purposes, it has been observed that the sealing membrane 17 behaves like a boat sail when pressurized.

The external delimiting wall 27 is an acoustic panel or sliding panel of the transcowl.

Each retention system 21 comprises a connecting element 35 configured to cooperate with a corresponding fastening point 37 of the fixed structure 3, here in particular of the front frame 5, on one end and configured to cooperate with the corresponding sealing membrane 17 at an attachment point 39 on another end, the attachment point 39 being in the cavity 31 in the thrust position.

The sealing membrane 17 is thus subjected to a return force in the direction opposite to the general direction of flow 11 by a simple mechanism for fastening the sealing membrane 17 to the front frame 5 via a connecting element 35.

The connecting element 35 is configured to be contained within a space delimited by the cavity 31 and the front frame 5 in the thrust position so as to be outside the secondary flow path 9.

In the thrust position, the first end 25 is located in the cavity 31 so that the sealing membrane 17 is at least partially in contact with the external delimiting wall 27 inside the cavity 31, the attachment point 39 being located at a determined distance from the first end 25.

The determined distance defines an intermediate position of total detachment of the sealing membrane 17 from the external delimiting wall 27 which is located between the thrust position and the thrust reversal position, the sealing membrane 17 no longer being in contact with the external delimiting wall 27 from the intermediate detachment position.

In other words, between the intermediate detachment position and the thrust reversal position, the sealing membrane 17 is no longer in contact with the movable structure 13 thanks to the action of the connecting element 35 as shown in FIGS. 4 and 7.

At the end of opening of the movable structure 13, the sealing membrane 17 does not disrupt the movement of the movable structure 13, which results in less effort to move the movable structure 13 at the end of opening and at the beginning of closing.

When closing towards the thrust position, the sealing membrane 17 comes into contact with the external delimiting wall 27 in the intermediate detachment position. It should be noted that the forces exerted by the sealing membrane 17 on the external delimiting wall 27 are, however, limited by the action of the connecting element 35, which holds the sealing membrane 17 upstream.

The determined distance defines the stage of opening of the movable structure 13 from which the connecting element 35 is tensioned and applies a return force on the sealing membrane 17.

The greater the determined distance, the earlier the return force on the sealing membrane 17 appears. One possibility is to define a force corresponding to an opening of approximately 80%. A more premature tensioning of the connecting element is in the range of 70% of the opening.

The tensioning by the connecting element 35 does not necessarily coincide with the moment when the sealing membrane 17 ceases to be in contact with the movable structure 13. The sealing membrane 17 may be tensioned while still in contact with the movable structure 13 and then detach completely from the movable structure 13 as the opening progresses.

The connecting element 35 is sized to extend in a straight line between the attachment point 39 and the fastening point 37 in the thrust position as illustrated in FIG. 2.

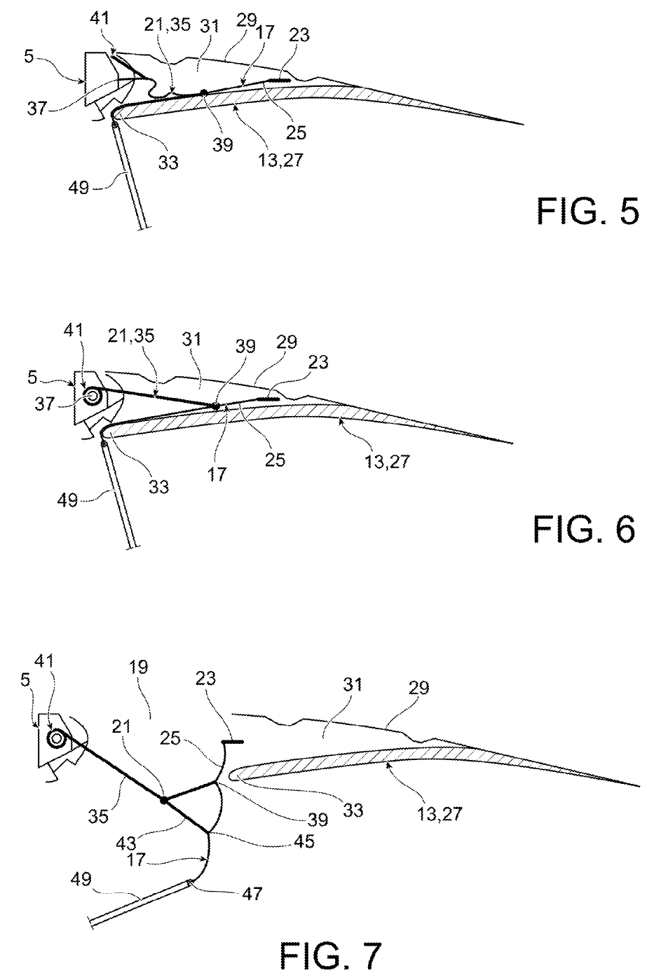

According to a variant shown in FIG. 5, the connecting element 35 may have a length greater than a straight-line distance between the attachment point 39 and the fastening point 37 in the thrust position. The connecting element 35 is then slack in the thrust position and at the beginning of travel towards the thrust reversal position.

The length of the connecting element 35 also influences the stage of opening of the movable structure 13 from which the connecting element 35 is tensioned.

The retention system 21 may optionally comprise an elastic retention device 41 configured to apply a return force to the connecting element 35 towards the fastening point as illustrated in FIGS. 5 to 7.

According to one possibility, illustrated in FIG. 5, the elastic retention device 41 is an elastic part connecting the front frame 5 to the connecting element 35. The elastic part can be a cord made of an extensible material fastened on the front frame 5 and the connecting element 35. This also works when the cord is fastened to another suitable location on the fixed part 3.

The elastic part is configured to extend as the movable structure 13 opens. This gradually and then completely detaches the sealing membrane 17 from the movable structure 13.

According to another possibility, illustrated in FIGS. 6 and 7, the elastic retention device 41 is a winder mounted on or formed into the front frame 5. The winder comprises a return spring sized to allow the sealing membrane 17 to gradually detach from the movable structure 13 during opening. As an alternative to the spring, a motor, for example an electric one, can be used as the return force.

The connecting element 35 is a cable or strap of fixed length. Alternatively, other devices could be used as long as they fulfill the function of connecting the front frame 5 to the sealing membrane 17.

The retention system 21 may also comprise a reinforcement element 43 configured to link the connecting element 35 to the sealing membrane 17 at a reinforcement location 45 separate from the attachment point 39 as illustrated in FIG. 7.

The reinforcement location 45, separate from the attachment point 39, makes it possible to define the shape assumed by the sealing membrane 17 in the thrust reversal position more precisely than with the attachment point 39 alone.

The reinforcement element 39 is a cable or strap made of the same material as the connecting element 39 and connected to the latter.

As also visible in FIG. 8, each sealing membrane 17 comprises a second end 47 opposite to the first end 25 and connected to the internal delimiting wall 7 by a corresponding connecting rod 49 or other mechanical system, the connecting rod 49 or the other mechanical system being configured to move the second end 47 between a lower position near or in contact with the internal delimiting wall 7 in the thrust reversal position and an upper position near or in contact with the external delimiting wall 27 in the thrust position.

In the lower position, the sealing membrane 17 extends into the secondary flow path 9 at least partially transversely to the general direction of flow 1 over almost all or all of the flow section, while in the upper position the sealing membrane 17 is almost or totally no longer present in the secondary flow path 9 and has entered the cavity.

The other mechanical system may comprise an arrangement of cables and corresponding guides connecting the second end 47 to the fixed structure 3, said arrangement being configured to be set in motion by the movement of the movable structure 13 between the thrust position and the thrust reversal position.

Each connecting rod 49 has a lower end 51 configured to be mounted on the internal delimiting wall 7, in one form via a pivot or ball joint.

Each connecting rod 49 is designed to move from the upper position in which said connecting rod 49 projects radially into the secondary flow path 9 to the lower position in which said connecting rod 49 is folded downstream.

In the upper position, each connecting rod 49 can adopt a radial or substantially radial orientation relative to the longitudinal central axis 15 of the thrust reverser 1, while in the lower position, each connecting rod 49 can adopt an axial or substantially axial orientation.

Each connecting rod 49 includes a return equipment configured to apply a force tending to tilt said connecting rod 49 towards the lower position. This provides proper positioning of the sealing membrane 17 during the transition to the thrust reversal position.

The connecting rods 49 are spaced circumferentially from each other within the secondary flow path 9, and their number can vary, for example, from two to ten, depending on the angular extent of the sealing membrane 17 as can be seen in FIG. 8.

The movable structure 13 is configured to slide relative to the fixed structure 3 via a rail-and-slide system of the thrust reverser 1, the rail-and-slide system being configured to guide the movable structure 13 from front to back during the opening phase of the reverser up to the thrust reversal position, and from back to front during the closing phase up to the thrust position.

As illustrated in FIG. 9, the thrust reverser 1 comprises a set of actuators 53 formed in the fixed structure 3 to move the movable structure 13 relative to the fixed structure 3.

The set of actuators 53 is configured to be set in motion by a cylinder 55 of the thrust reverser 1 associated with a flexible shaft 57 of the thrust reverser 1. A dedicated control assembly 59 of the thrust reverser 1 controls the cylinder 55 and the set of actuators 53.

The thrust reverser 1 comprises at least one set of cascade vanes having an angular amplitude identical or similar to that of the corresponding cowl. The set of cascades is fastened and extends between the front frame and the rear frame.

It thus appears that the retention system(s) 21 make it possible to limit the movement of the corresponding sealing membrane 17 in the general direction of flow 11 and thus to avoid or limit the stress of the sealing membrane 17 on the movable structure 13.

This arrangement thus facilitates the movement of the movable structure 13 which is little disrupted by the presence of the sealing membrane 17.

Moreover, the use of the retention system 21 makes it possible to avoid oversizing the cylinder 55. Indeed, without the retention system 21, the sealing membrane 17 is in contact with the external delimiting wall 27 which creates resistance to the movement of the movable structure 13, particularly at the end of opening and during the closing of the movable structure 13.

As it goes without saying, the present disclosure is not limited to the sole form described above as an example, it encompasses on the contrary all variants thereof.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to

be within the scope of the disclosure. Such variations are not to be regarded as a departure from the spirit and scope of the disclosure.

What is claimed is:

1. A thrust reverser for an aircraft propulsion unit, the thrust reverser comprising:
a fixed structure having a front frame and an internal delimiting wall for a secondary flow path of the aircraft propulsion unit, the secondary flow path configured to be traversed by a secondary flow in a general direction of flow,
a movable structure including at least one cowl, the movable structure movable in translation relative to the fixed structure along a longitudinal central axis of the thrust reverser between a thrust position and a thrust reversal position,
at least one sealing membrane configured to divert at least part of the secondary flow outwards through a radial opening formed between the front frame and the movable structure in the thrust reversal position, and the at least one sealing membrane extends into the secondary flow path in the thrust reversal position,
at least one retention system that cooperates with the fixed structure and the at least one sealing membrane, the at least one retention system configured to apply a return force to the at least one sealing membrane, the return force comprising a component opposite to the general direction of flow in the thrust reversal position,
wherein the fixed structure includes a rear frame, the at least one sealing membrane having a first end coupled to the rear frame,
wherein the at least one cowl comprises an external delimiting wall configured to delimit the secondary flow path with the internal delimiting wall in the thrust position and an external panel having an outer aerodynamic surface of the thrust reverser,
wherein the at least one cowl has a cavity open towards the front frame in the thrust position and formed between the external delimiting wall and the external panel, the rear frame located in the cavity in the thrust position so that the at least one sealing membrane is at least partially in the cavity in the thrust position, and
wherein the at least one retention system comprises a connecting element configured to cooperate with a fastening point of the fixed structure on one end of the connecting element and configured to cooperate with the at least one sealing membrane at an attachment point on another end of the connecting element, and the attachment point is in the cavity in the thrust position.

2. The thrust reverser according to claim 1, wherein the connecting element is configured to be contained within a space delimited by the cavity and the front frame in the thrust position so as to be outside of the secondary flow path.

3. The thrust reverser according to claim 1, wherein, in the thrust position, the first end is located in the cavity so that the at least one sealing membrane is at least partially in contact with the external delimiting wall inside the cavity, the attachment point located at a predetermined distance from the first end, the predetermined distance defining an intermediate position of a total detachment of the at least one sealing membrane from the external delimiting wall which is located between the thrust position and the thrust reversal position, and the at least one sealing membrane is no longer in contact with the external delimiting wall at the intermediate position.

4. The thrust reverser according to claim 1, wherein the connecting element is sized to extend in a straight line between the attachment point and the fastening point in the thrust position.

5. The thrust reverser according to claim 1, wherein the at least one retention system further comprises an elastic retention device configured to apply the return force to the connecting element towards the fastening point.

6. The thrust reverser according to claim 1, wherein the at least one retention system also comprises a reinforcement element configured to link the connecting element to the at least one sealing membrane in a reinforcement location separate from the attachment point.

7. The thrust reverser according to claim 1, wherein the at least one sealing membrane comprises a second end opposite the first end and connected to the internal delimiting wall by a connecting rod, and the connecting rod is configured to move the second end between a lower position near the internal delimiting wall in the thrust reversal position and an upper position near the external delimiting wall in the thrust position.

8. The thrust reverser according to claim 1, wherein the movable structure is configured to slide relative to the fixed structure via a rail-and-slide system of the thrust reverser, the rail-and-slide system is configured to guide the movable structure from front to back during an opening phase of the thrust reverser up to the thrust reversal position,
and from back to front during a closing phase of the thrust reverser up to the thrust position, and the thrust reverser includes a set of actuators formed in the fixed structure that move the movable structure relative to the fixed structure.
